(19) United States
(12) Patent Application Publication
(10) Pub. No.: US 2026/0321459 A1
(43) Pub. Date: Oct. 15, 2026

(54) COMMUNICATION CABLE

(71) Applicant: Yazaki Corporation, Tokyo (JP)

(72) Inventors: Haruna YAMAZAKI, Shizuoka (JP); Yutaka HANDA, Shizuoka (JP); Takeshi OSHIMA, Shizuoka (JP); Syuichi INOUE, Shizuoka (JP)

(73) Assignee: Yazaki Corporation, Tokyo (JP)

(21) Appl. No.: 19/641,742

(22) Filed: Apr. 8, 2026

(30) Foreign Application Priority Data
Apr. 15, 2025 (JP) 2025-066873
Dec. 23, 2025 (JP) 2025-277769

(51) Int. Cl. H01B 7/30; H01B 7/295; H01B 11/00; H01B 11/12

(52) U.S. Cl. CPC H01B 7/30; H01B 7/295; H01B 11/002; H01B 11/12

(57) ABSTRACT

A communication cable includes two insulated electric wires that are twisted together, the two insulated electric wires each including a conductor and an insulator covering the conductor. Further, the communication cable includes a metal foil shield that is provided around the two insulated electric wires by lateral winding, and a sheath that is provided on an outer periphery of the metal foil shield. The insulator is a foamed body, and a foaming ratio of the insulator is 39% or less. A concentricity of each of the two insulated electric wires is 94% or more and 100% or less.

### CROSS-REFERENCE TO RELATED APPLICATIONS

The present application is based upon and claims the benefit of priority from Japanese Patent Applications No. 2025-066873, filed on Apr. 15, 2025, and No. 2025-277769, filed on Dec. 23, 2025, the entire contents of which are incorporated herein by reference.

### TECHNICAL FIELD

The present disclosure relates to a communication cable.

### BACKGROUND

A communication cable mounted on a vehicle such as an automobile is required to have advanced communication performance. As a signal transmission line for performing communication in a high-frequency band in the GHz range, JP 2015-185527 A discloses a two-core parallel shielded electric wire in which two insulated electric wires arranged in parallel are longitudinally covered with a metal foil resin tape and a resin tape is wound around the outside thereof.

### SUMMARY OF THE INVENTION

However, in JP 2015-185527 A, it is necessary to reduce the line speed in order to maintain the two insulated electric wires in parallel with high precision, which may degrade manufacturability of the communication cable. Further, in JP 2015-185527 A, when the concentricity of the signal transmission line varies in the longitudinal direction, a sharp signal attenuation (suck-out) may occur at a specific frequency, and communication performance may be degraded.

The present disclosure has been made in view of such a problem in the related art. Further, an object of the present disclosure is to provide a communication cable with improved manufacturability and communication stability.

A communication cable according to an aspect of the present disclosure includes two insulated electric wires that are twisted together, the two insulated electric wires each including a conductor and an insulator covering the conductor, a metal foil shield that is provided around the two insulated electric wires by lateral winding, and a sheath that is provided on an outer periphery of the metal foil shield. The insulator is a foamed body, and a foaming ratio of the insulator is 39% or less. A concentricity of each of the two insulated electric wires is 94% or more and 100% or less.

According to the present disclosure, it is possible to provide a communication cable with improved manufacturability and communication stability.

### BRIEF DESCRIPTION OF DRAWINGS

FIG. 1 is a side view illustrating an example of a communication cable according to an embodiment.

FIG. 2 is a cross-sectional view illustrating an example of the communication cable according to the embodiment.

FIG. 3 is a cross-sectional view illustrating an example of an insulated electric wire.

FIG. 4 is a cross-sectional view illustrating an example of the insulated electric wire.

FIG. 5 is a graph illustrating a relationship between a frequency and an insertion loss in Experiment 1.

FIG. 6 is a graph illustrating a relationship between a frequency and an insertion loss in Experiment 2.

FIG. 7 is a graph illustrating a relationship between a frequency and an insertion loss in Experiment 3.

FIG. 8 is a graph illustrating a relationship between a frequency and an insertion loss in Experiment 3.

FIG. 9 is a graph illustrating a relationship between a frequency and an insertion loss in Experiment 4.

FIG. 10 is a graph illustrating a relationship between a frequency and an insertion loss in Experiment 4.

FIG. 11 is a graph illustrating a relationship between a frequency and an insertion loss in Experiment 5.

### DETAILED DESCRIPTION OF THE INVENTION

With reference to the drawings, a communication cable according to an embodiment of the present disclosure is described below in detail. Note that the dimensional ratios in the drawings are exaggerated for explanatory purposes, and may differ from the actual ratios.

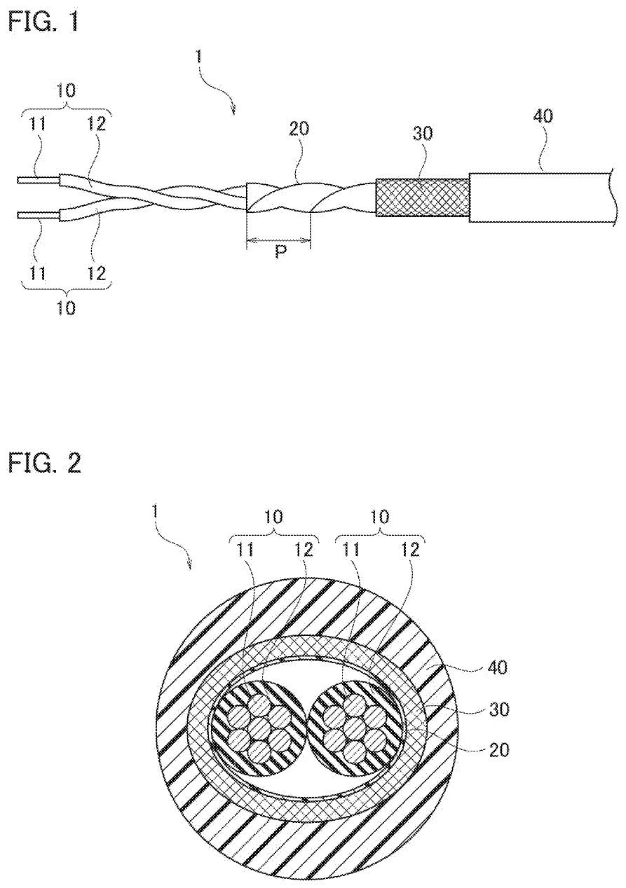

As illustrated in FIG. 1, a communication cable 1 is a two-core twisted shielded cable including two insulated electric wires 10 that are twisted together, the two insulated electric wires each including a conductor 11 and an insulator 12 covering the conductor 11. Further, the communication cable 1 includes a metal foil shield 20 that is provided around the two insulated electric wires 10 by lateral winding, and a sheath 40 that is provided on an outer periphery of the metal foil shield 20. Further, the communication cable 1 may include a metal braid 30 provided between the metal foil shield 20 and the sheath 40 so as to cover the outer periphery of the metal foil shield 20.

### [Insulated Electric Wire]

The insulated electric wire 10 includes the conductor 11 and the insulator 12 covering the conductor 11. The conductor 11 may be formed by a single element wire, may be formed by seven element wires as illustrated in FIG. 2, or may be a collective stranded wire formed by bundling a plurality of element wires. Further, the conductor 11 may be formed by a single stranded wire, or may be a composite stranded wire formed by bundling a plurality of collective stranded wires. Further, the conductor 11 may be a compressed conductor or a non-compressed conductor. The material forming the conductor 11 is not particularly limited, but is preferably at least one conductive metal material selected from the group consisting of copper, a copper alloy, aluminum, and an aluminum alloy. Further, as the material forming the conductor 11, a soft copper wire, a silver-plated soft copper wire, a tin-plated soft copper wire, or a tin-plated copper alloy may also be used, but it is preferably free of plating. When the material forming the conductor 11 is free of plating, communication performance can be maintained on a vehicle for a long period.

The cross-sectional area of the conductor 11 is not particularly limited, but is preferably 0.22 sq or less. By setting the cross-sectional area of the conductor 11 to 0.22 sq or less, routing of the insulated electric wire 10 can be facilitated even in a narrow and short path. In the case of FIG. 2, the cross-sectional area of the conductor 11 means the total cross-sectional area of the seven element wires. Further, 0.22 sq means 0.22±0.02 mm². By setting the cross-sectional area of the conductor 11 to 0.22 sq or less, the outer diameter of the inner wire is not excessively increased, and the insulated electric wire 10 is less likely to be crushed by twisting within a range of a twist pitch, which is described later.

The insulator 12 is a foamed body. Further, as a base resin forming the insulator 12, an electrically insulating resin can be arbitrarily used in order to secure electrical insulation for the conductor. As the base resin forming the insulator 12, it is preferred to include at least one selected from the group consisting of foamed polyethylene, crosslinked foamed polyethylene, foamed polypropylene, crosslinked foamed polypropylene, and foamed polytetrafluoroethylene. Those materials may be used alone, or two or more kinds thereof may be used in combination.

The base resin forming the insulator 12 is more preferably foamed polypropylene from the viewpoints of heat resistance and versatility in manufacturing. Examples of polypropylene used as the base resin forming the insulator 12 include homopolypropylene (homo PP), random polypropylene (random PP), block polypropylene (block PP), and copolymers with other olefin components copolymerizable with propylene. Examples of other olefins copolymerizable with propylene include α-olefins such as ethylene, 1-butene, isobutylene, 1-pentene, 3-methyl-1-butene, 1-hexene, 3,4-dimethyl-1-butene, 1-heptene, and 3-methyl-1-hexene.

The characteristic impedance of the communication cable 1 used as an in-vehicle communication cable preferably satisfies 100±5Ω. In order to set the characteristic impedance to 100±5Ω, the relative permittivity of the insulator 12 is preferably 1.55 or more and 2.07 or less. Reduction in weight and size is required for an in-vehicle communication cable. However, when the relative permittivity is large, it is necessary to increase the finished outer diameter of the insulated electric wire 10. When the relative permittivity of the insulator 12 falls within the above-mentioned range, the present embodiment is applicable even to a communication cable including a smallest-diameter conductor with a cross-sectional area of 0.13 sq (mm²) specified in ISO 21111-8, and the characteristic impedance can be controlled within a range of 100±5Ω. Note that the relative permittivity can be measured by a cavity resonator method at a frequency of 10 GHz in an atmosphere at 30° C.

A foaming ratio of the insulator 12 is 39% or less, and is preferably 15% or more and 39% or less. By setting the foaming ratio of the insulator 12 to 39% or less, the characteristic impedance of the communication cable 1 can be controlled within a range of 100±5Ω. Further, by setting a foaming ratio of foamed polypropylene to 39% or less, crushing of the insulated electric wire 10 is less likely to occur, and occurrence of suck-out can be prevented. Note that the foaming ratio can be confirmed by observing, with an electron microscope, a cut surface obtained by cutting the insulated electric wire 10 in a cross-sectional direction or a longitudinal direction, regarding the ratio of the area occupied by foam in a cross-sectional area of the insulator 12 as the foaming ratio, and calculating an average value of the foaming ratios in the cross-sectional direction and the longitudinal direction. Alternatively, the foaming ratio can also be confirmed by a method in which a cut surface of the insulated electric wire 10 in a cross-sectional direction or a longitudinal direction is observed non-destructively by X-ray micro-CT, and an average value of the foaming ratio is calculated.

The insulator 12 can be produced by a publicly known molding method such as foam extrusion molding. Further, the insulator 12 is preferably formed by a physical foaming method in which an inert gas is injected. By using the physical foaming method, an amount of a foaming agent to be added can be small, and a communication cable with excellent communication performance and a reduced environmental impact can be manufactured.

The thickness of the insulator 12 is not particularly limited, but is preferably 0.15 mm or more, more preferably 0.18 mm or more. By setting the thickness of the insulator 12 as described above, the conductor 11 can be effectively protected. Further, the thickness of the insulator 12 is not particularly limited, but is preferably 0.5 mm or less. By setting the thickness of the insulator 12 as described above, routing of the insulated electric wire 10 can be facilitated even in a narrow path.

A D hardness of the insulator 12 is 60 or more and 70 or less, and is preferably 62 or more and 67 or less. By setting the D hardness of the insulator 12 to 60 or more, crushing of the insulated electric wire 10 due to twisting and foil winding is less likely to occur, and occurrence of suck-out can be prevented. Further, by setting the D hardness of the insulator 12 to 70 or less, distortion during twisting can be suppressed, and the twisted wire is less likely to open. Note that the D hardness can be measured in accordance with Japanese Industrial Standard JIS K 7215 (Testing Methods for Durometer Hardness of Plastics).

As additives to be added to the base resin forming the insulator 12, various additives may be appropriately blended within a range that does not impair the effects of the present embodiment. Examples of such additives include an antioxidant, a copper inhibitor, a flame retardant, an inorganic filler, a flame-retardant auxiliary, a processing aid, a crosslinking agent, a metal deactivator, an anti-aging agent, a filler, a reinforcing agent, an ultraviolet absorber, a stabilizer, a plasticizer, a pigment, a dye, a colorant, an antistatic agent, and a foaming agent.

As a method of blending the above-described additives into the base resin forming the insulator 12, a publicly known means can be used. For example, a resin composition forming the insulator 12 can be obtained by kneading using a publicly known kneading machine such as a Banbury mixer, a kneader, a roll mill, a twin-screw extruder, and a single-screw extruder.

In the insulated electric wire 10 of the present embodiment, a publicly known method can also be used to cover the conductor 11 with the insulator 12, and for example, it can be produced by a general extrusion molding method. Specifically, the insulator 12 can be formed by extruding and covering the material of the insulator 12 on the outer surface of the conductor 11 formed by one or a plurality of element wires. As an extruder used in the extrusion molding method, for example, a single-screw extruder or a twin-screw extruder including a screw, a breaker plate, a crosshead, a distributor, a nipple, and a die can be used.

### [Twisted Wire]

The twisted wire is obtained by twisting the two insulated electric wires 10 together, each of which includes the conductor 11 and the insulator 12 covering the outer periphery of the conductor 11. As illustrated in FIG. 1, the external appearance of the twisted wire is in the form of a stranded wire formed by twisting the two insulated electric wires 10 together. Further, FIG. 2 illustrates cross sections of the two insulated electric wires 10 adjacent to each other.

The two insulated electric wires 10 forming the twisted wire have the same configuration. In the twisted wire, electric currents of opposite phases are caused to flow through the two insulated electric wires. Accordingly, the twisted wire is configured to transmit a signal based on a potential difference between the two insulated electric wires 10. However, when a concentricity of the two insulated electric wires 10 varies in the longitudinal direction, suck-out may occur at a specific frequency. Thus, the concentricity of each of the two insulated electric wires 10 is 94% or more and 100% or less. By setting the concentricity of the two insulated electric wires 10 to 94% or more and 100% or less, occurrence of suck-out can be prevented, and variation in impedance can be reduced as described later. Note that a method of adjusting the concentricity is not particularly limited, but it can be adjusted, for example, when the conductor 11 is covered with the insulator 12.

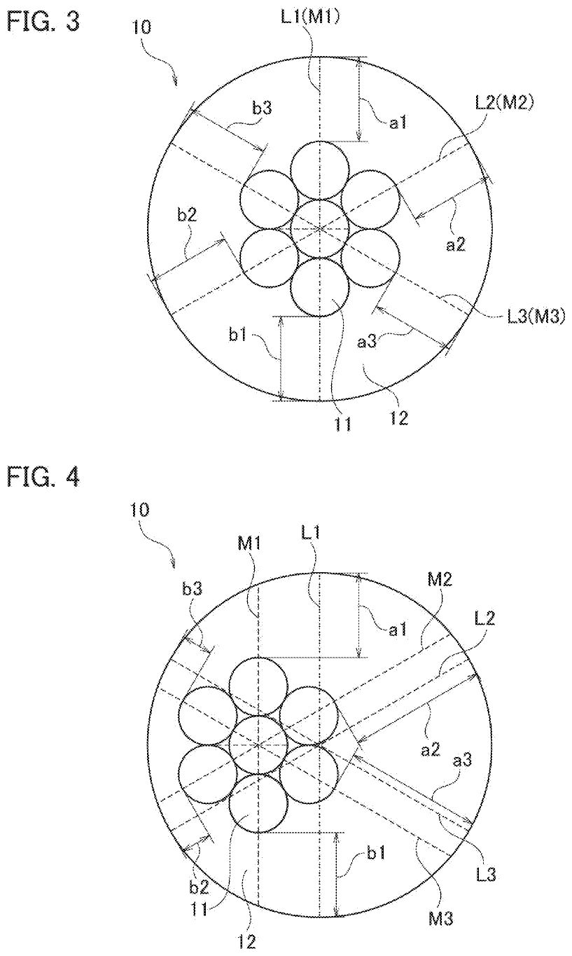

The concentricity of the two insulated electric wires 10 is measured by the following method. FIG. 3 illustrates a cross-sectional view when the center of the conductor 11 matches with the center of the insulated electric wire 10. First, straight lines L1, L2, and L3 are drawn so as to divide the insulated electric wire 10 into six equal parts in the circumferential direction. Next, straight lines M1, M2, and M3 are drawn so as to divide the conductor 11 into six equal parts in the circumferential direction. Note that, in FIG. 3, the center of the conductor 11 matches with the center of the insulated electric wire 10, and hence the straight lines L1 and M1, the straight lines L2 and M2, and the straight lines L3 and M3 completely match with each other. Further, on the straight line L1 (M1), one thickness of the insulator 12 located outside the conductor 11 is defined as a1, and the other thickness thereof is defined as b1. Similarly, on the straight line L2 (M2), one thickness of the insulator 12 located outside the conductor 11 is defined as a2, and the other thickness thereof is defined as b2. On the straight line L3 (M3), one thickness of the insulator 12 located outside the conductor 11 is defined as a3, and the other thickness thereof is defined as b3. Further, the concentricity of the insulated electric wire 10 can be calculated by Equation (1) given below.

$$\begin{matrix}[ Math . 1 ] & \\ C = \frac{( \frac{b 1}{a 1} + \frac{b 2}{a 2} + \frac{b 3}{a 3} )}{3} \times 100 & ( 1 )\end{matrix}$$

In Equation (1) given above, C represents the concentricity (%). In other words, a ratio of the thicknesses of the insulator 12 is calculated on each of the straight lines L1 (M1), L2 (M2), and L3 (M3), and an average value of the three points is regarded as the concentricity at that position. Further, an average value of concentricities measured at ten positions every 1 m in the longitudinal direction of the insulated electric wire 10 is defined as the concentricity of the insulated electric wire 10. Note that, in the case of FIG. 3, since a1=b1, a2=b2, and a3=b3 are respectively satisfied, the concentricity C of the insulated electric wire 10 is 100%.

FIG. 4 illustrates a cross-sectional view in a case where the center of the conductor 11 does not match with the center of the insulated electric wire 10. First, the straight lines L1, L2, and L3 are drawn so as to divide the insulated electric wire 10 into six equal parts in the circumferential direction. Next, the straight lines M1, M2, and M3 are drawn so as to divide the conductor 11 into six equal parts in the circumferential direction. At this time, the straight lines L1 and M1, the straight lines L2 and M2, and the straight lines L3 and M3 are parallel to each other, respectively. Further, a tangent line is drawn at one intersection point between the straight line M1 and the outer periphery of the conductor 11, and the thickness of the insulator 12 starting from the point where this tangent line intersects with the straight line L1 is defined as a1. Further, a tangent line is drawn at the other intersection point between the straight line M1 and the outer periphery of the conductor 11, and the thickness of the insulator 12 starting from the point where this tangent line intersects with the straight line L1 is defined as b1 (provided that a1≥ b1).

Similarly, a tangent line is drawn at one intersection point between the straight line M2 and the outer periphery of the conductor 11, and the thickness of the insulator 12 starting from the point where this tangent line intersects with the straight line L2 is defined as a2. A tangent line is drawn at the other intersection point between the straight line M2 and the outer periphery of the conductor 11, and the thickness of the insulator 12 starting from the point where this tangent line intersects with the straight line L2 is defined as b2 (provided that a2≥b2). Further, a tangent line is drawn at one intersection point between the straight line M3 and the outer periphery of the conductor 11, and the thickness of the insulator 12 starting from the point where this tangent line intersects with the straight line L3 is defined as a3. A tangent line is drawn at the other intersection point between the straight line M3 and the outer periphery of the conductor 11, and the thickness of the insulator 12 starting from the point where this tangent line intersects with the straight line L3 is defined as b3 (provided that a3≥b3). The concentricity of the insulated electric wire 10 can be calculated by Equation (1) given above by using the values of the thicknesses a1 to a3 and b1 to b3 of the insulator 12 obtained as described above.

The characteristic impedance of the twisted wire can be calculated by Equation (2) given below.

$$\begin{matrix}[ Math . 2 ] & \\ {Z}_{0} = \frac{276}{\sqrt{{ε}_{e}}} {log}_{10} \frac{1.2 B}{d} & ( 2 )\end{matrix}$$

In Equation (2) given above, Zo represents the characteristic impedance (Q), ¿e represents the relative permittivity of the insulator 12, d represents the outer diameter (mm) of the conductor 11, B represents the distance (mm) between the centers of the conductors 11. In other words, the characteristic impedance theoretically depends on the distance between the centers of the conductors 11. Thus, as described above, by setting the concentricity of each of the two insulated electric wires 10 to 91% or more and 100% or less, variation in impedance can be reduced.

The twist pitch of the twisted wire is preferably 15 mm or more and 21 mm or less. By setting the twist pitch of the twisted wire to 15 mm or more and 21 mm or less, crushing and unraveling of the inner wire (the insulated electric wire 10) can be prevented, and variation in impedance can be reduced.

A coupling ratio of the twisted wire can be calculated by Equation (3) given above.

$$\begin{matrix}[ Math . 3 ] & \\ C R = \frac{( {Z}_{e v e n} - {Z}_{o d d} )}{( {Z}_{e v e n} + {Z}_{o d d} )} \times 100 & ( 3 )\end{matrix}$$

In Equation (3) given above, CR represents the coupling ratio (%), Z_{odd} represents an odd-mode impedance (2), and Zₑᵥₑₙ represents an even-mode impedance ((2). The odd-mode impedance and the even-mode impedance can be calculated by Equation (4) and Equation (5) given above.

[Math. 4]

Z_{diff}=2×Z_{odd} (4)

In Equation (4) given above, Z_{diff} represents a differential-mode impedance (Ω). The differential-mode impedance is an impedance generated between the two insulated electric wires 10 with respect to electric currents in which signals of the two insulated electric wires 10 flow in opposite directions, and is determined by coupling between the two insulated electric wires 10, such as an inter-conductor distance, a conductor diameter, and a material.

[Math. 5]

Z_{common}=0.5×Zₑᵥₑₙ (5)

In Equation (5) given above, Z_{common} represents a common-mode impedance (Ω). The common-mode impedance refers to an impedance generated between the two insulated electric wires 10 and the ground with respect to electric currents in which signals of the two insulated electric wires 10 flow in the same direction.

In a relationship between a frequency and an insertion loss (IL), the insertion loss is generally small in a low-frequency range, but tends to increase in a high-frequency range. Further, by increasing the coupling ratio of the twisted wire and strengthening coupling between the two insulated electric wires 10, the insertion loss in the high-frequency range can be suppressed. For example, when the cross-sectional area of the conductor 11 is 0.22 sq or less, the coupling ratio of the twisted wire is preferably 12.0% or more and 20.0% or less, more preferably 12.0% or more and 15.0% or less. By setting the coupling ratio of the twisted wire to 12.0% or more, the insertion loss in the high-frequency range can be suppressed. For example, when the cross-sectional area of the conductor 11 is 0.22 sq, the insertion loss around a frequency of 9 GHz in the high-frequency range is preferably −3 dB/m or more. Further, when the cross-sectional area of the conductor 11 is 0.13 sq, the insertion loss around a frequency of 9 GHz is preferably −3.5 dB/m or more. On the other hand, by setting the coupling ratio of the twisted wire to 20.0% or less, good manufacturability of the communication cable can be achieved.

### [Metal Foil Shield]

The communication cable 1 includes the metal foil shield 20 that is provided around the two insulated electric wires 10 by lateral winding. The term “lateral winding” means that the metal foil shield 20 is wound in a spiral manner as illustrated in FIG. 1. By providing the metal foil shield 20 by lateral winding, the communication cable is bent easily, and routability can be ensured, as compared with a case where the metal foil shield 20 is provided in a longitudinally laid manner. Note that a holding film provided so as to cover an outer periphery of the two insulated electric wires 10 may be arranged between the two insulated electric wires 10 and the metal foil shield 20. In other words, the metal foil shield 20 may be provided around the two insulated electric wires 10 by lateral winding via the holding film. As the holding film, for example, a polyethylene terephthalate (PET) film can be used.

The metal foil shield 20 is a shield member provided around the two insulated electric wires 10 by lateral winding. The metal foil shield 20 includes a resin layer and a metal layer. Further, the metal foil shield 20 may be superposed and wound around the two insulated electric wires 10 so that the metal layer is positioned on the outer side. Further, the metal foil shield 20 preferably has a three-layer structure including the resin layer, an adhesive layer that integrally bonds the resin layer and the metal layer, and the metal layer. In other words, the metal layer, the adhesive layer, and the resin layer are preferably laminated in this order from the outer side, and are preferably superposed and wound around the two insulated electric wires 10.

The resin layer of the metal foil shield 20 is not particularly limited as long as it is a layer of a non-conductive resin, but may include, for example, PET, or may be a PET film. Further, the resin layer may be any of an unstretched film, a uniaxially stretched film, or a biaxially stretched film, but is preferably a biaxially stretched film stretched in both the longitudinal and transverse directions from the viewpoint of strength.

The metal layer of the metal foil shield 20 is not particularly limited as long as it is a layer of a conductive metal, but preferably contains at least one of aluminum or copper, and more preferably contains aluminum from the viewpoint of cost. Note that, from the viewpoint of securing shielding performance, the thickness of the metal layer is preferably 8 μm or more when the metal layer contains copper, and preferably 10 μm or more when the metal layer contains aluminum.

A ratio of the thickness of the metal layer with respect to the thickness of the resin layer in the metal foil shield 20 is 0.4 or more and 1.2 or less. By setting the ratio of the thickness of the metal layer with respect to the thickness of the resin layer to 0.4 or more, the rigidity of the resin layer is not excessively high, damage to the insulated electric wire 10 can be suppressed when the metal foil shield 20 is wound along the twisted wire, and occurrence of suck-out can be prevented. Further, by setting the ratio of the thickness of the metal layer with respect to the thickness of the resin layer to 1.2 or less, the resin layer is not excessively thin, and cutting during manufacturing of the communication cable is less likely to occur.

The thickness of the metal foil shield 20 is preferably 15 μm or more and 50 μm or less. By setting the thickness of the metal foil shield 20 to 15 μm or more, cutting of the metal foil shield 20 during manufacturing of the communication cable is less likely to occur. Further, by setting the thickness of the metal foil shield 20 to 50 μm or less, the metal foil shield 20 is not excessively rigid, and the metal foil shield 20 can be easily wound along the twisted wire.

A foil winding pitch P of the metal foil shield 20, which is illustrated in FIG. 1, is preferably 18.5 mm or less. The suck-out frequency of the twisted wire obtained by twisting the two insulated electric wires 10 can be calculated by Equation (6) given above.

$$\begin{matrix}[ Math . 6 ] & \\ f = \frac{c}{{ε}_{r}^{0.89} \times \sqrt{P} \times 4 \times 1 {0}^{6}} & ( 6 )\end{matrix}$$

In Equation (6) given above, f represents the suck-out frequency (GHz), c represents the speed of light, ¿, represents the inner wire relative permittivity (the relative permittivity of the insulator 12), and P represents the foil winding pitch (mm) of the metal foil shield 20. As described above, when the relative permittivity of the insulator 12 is 1.55 or more and 2.07 or less, the foil winding pitch P of the metal foil shield 20 is 18.5 mm or less, and hence the suck-out frequency is 9 GHz or higher. Thus, in the communication cable 1, occurrence of suck-out can be prevented up to a frequency of 9 GHz. In order to cope with CASE (“Connected”, “Autonomous”, “Shared & Services”, and “Electric”), which is a trend in the automobile industry, the communication speed is expected to increase to up to 25 Gbps. To achieve this communication speed, it is required to prevent occurrence of suck-out in a high-frequency range up to a frequency of 9 GHz in the communication cable.

### [Metal Braid]

The communication cable 1 may include the metal braid 30 provided between the metal foil shield 20 and the sheath 40 so as to cover the outer periphery of the metal foil shield 20. The metal braid 30 is formed, for example, by bundling a plurality of metal wires such as soft copper wires, silver-plated soft copper wires, tin-plated soft copper wires, or tin-plated copper alloy wires, and braiding those bundles. Note that the metal wires may be plated fibers in which a metal plating is applied to fibers. Further, the metal braid 30 may be formed by braiding flat bundles obtained by collectively plating a plurality of metal wires.

### [Sheath]

The communication cable 1 includes the sheath 40 provided to the outer periphery of the metal foil shield 20. When the metal braid 30 is provided between the metal foil shield 20 and the sheath 40, the sheath 40 is provided so as to cover an outer periphery of the metal braid 30.

A material of a base resin forming the sheath 40 is not particularly limited as long as electrical insulation can be secured, but for example, a publicly known insulating resin such as crosslinked polyethylene, an olefin resin such as polypropylene, and polyvinyl chloride can be arbitrarily used. Note that the sheath 40 is not limited to a solid state, and may be formed in a tubular shape and arranged so as to have a partial gap with respect to the inner metal foil shield 20 or the metal braid 30. Alternatively, some other intervening material may be provided in the gap.

A flame retardant such as an inorganic flame retardant including metal hydroxides and a halogen-based flame retardant is preferably added to the base resin forming the sheath 40 in order to secure flame retardancy required as a property of an electric wire. In addition, an additive such as an antioxidant and a plasticizer may be appropriately blended into the base resin forming the sheath 40 within a range that does not impair the effects of the present embodiment, similarly to the insulator 12.

A method of covering the metal foil shield 20 or the metal braid 30 with the sheath 40 can employ a publicly known means in the same manner as for the insulator 12, and the sheath 40 can be produced by a general extrusion molding method, for example. The thickness of the sheath 40 is not particularly limited, but may be 0.1 mm to 1 mm, for example.

As described above, the communication cable 1 includes the two insulated electric wires 10 that are twisted together, the two insulated electric wires each including the conductor 11 and the insulator 12 covering the conductor 11. Further, the communication cable 1 includes the metal foil shield 20 that is provided around the two insulated electric wires 10 by lateral winding, and the sheath 40 that is provided on the outer periphery of the metal foil shield 20. The insulator 12 is a foamed body, the foaming ratio of the insulator 12 is 39% or less, and the concentricity of each of the two insulated electric wires 10 is 94% or more and 100% or less. Thus, in the communication cable 1, damage to the insulated electric wire 10 caused by twisting and foil winding during manufacturing of the communication cable can be suppressed, and occurrence of suck-out can be prevented. Consequently, according to the communication cable 1 according to the present embodiment, it is possible to provide a communication cable with improved manufacturability and communication stability. Further, in the communication cable 1, by providing the metal foil shield 20 by lateral winding and adjusting the foil winding pitch, routing performance is also ensured, and excellent communication stability in a high-frequency range up to 10 GHz is achieved.

### Examples

The present embodiment is further described below in detail by Examples and Comparative Examples. However, the present embodiment is not limited to those examples.

### [Experiment 1]

Examples 1-1 and 1-2 and Comparative Example 1-1 were used to verify the influence of differences in the concentricity of the insulated electric wires forming the twisted wire on communication stability.

As a method of producing the insulated electric wire, first, polypropylene was foam-extruded onto a stranded conductor (cross-sectional area: 0.13 sq, outer diameter: 0.48 mm) formed by twisting seven soft copper element wires together, and an insulator (foamed polypropylene) was thus formed. The temperature of the extruder for foam extrusion molding was set to 170 to 220° C., and high-pressure nitrogen gas pressurized by a gas booster was injected and mixed from a middle portion of the extruder. At that time, the foaming ratio of the insulator was set to 35% in all cases. Further, the concentricity of the insulated electric wire was set to 97% in Example 1-1, 94% in Example 1-2, and 90% in Comparative Example 1-1. In each case, two insulated electric wires were produced under the above-mentioned conditions.

The foaming ratio was confirmed by using X-ray micro-CT (nano3DX) to capture CT images of the insulated electric wire (in the cross-sectional direction and the longitudinal direction). The imaging conditions were set to a spatial resolution of 4.31 μm/voxel, an X-ray camera lens L1080, a binning setting of 3, an exposure time of 4 seconds, an X-ray source of Cu (40 kV, 30 mA), a field of view of 3.626×2.719 mm, and 400 images. Further, for the captured images, the foaming ratio was calculated as an average value by using the analysis software ImageJ.

The obtained insulated electric wires were twisted together to produce the twisted wire. The twist pitch of the twisted wire was set to 17 mm. Further, a metal foil shield was provided around the twisted wire by lateral winding. The resin layer of the metal foil shield was a PET film, and the thickness of the resin layer was 12 μm. The metal layer of the metal foil shield was aluminum, and the thickness of the metal layer was 10 μm. Thus, the ratio of the thickness of the metal layer to the thickness of the resin layer was 0.83. Note that the thickness of the metal foil shield was 50 μm or less.

Further, after a metal braid formed of metal wires was provided on an outer periphery of the metal foil shield, the assembly was set in an extruder (set temperature: 140 to 180° C.), and was covered with a sheath having a thickness of 0.4 mm by extrusion molding to produce a test sample of the communication cable.

In order to evaluate communication stability of the communication cable, an insertion loss was measured. Specifically, by using a vector network analyzer (VNA) (E5071C manufactured by Keysight Technologies), the insertion loss of the communication cable was measured under conditions where the measurement frequency was 1 MHz to 10 GHz and the measurement bandwidth was 1 kHz.

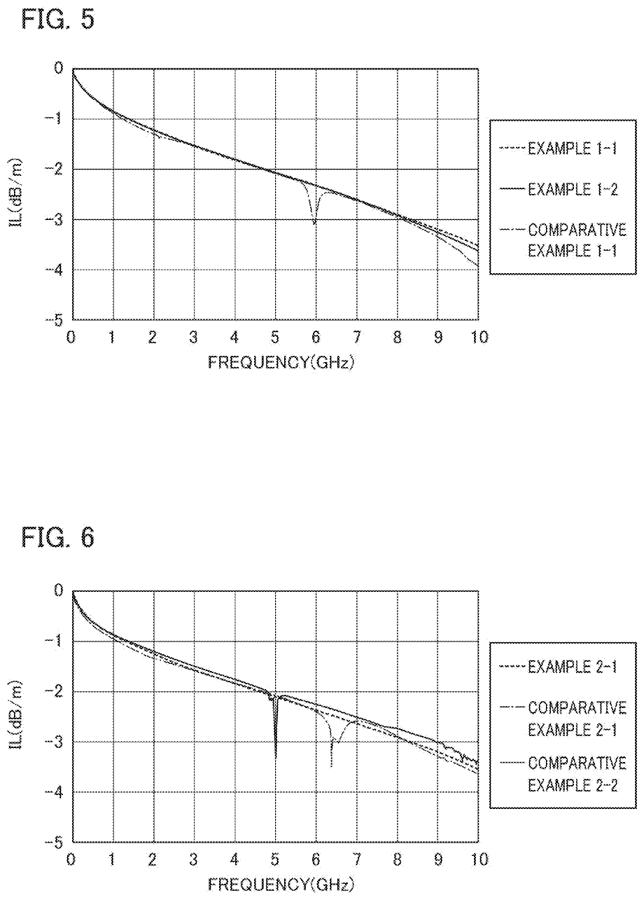

FIG. 5 is a graph comparing communication stability of the communication cables according to Examples 1-1 and 1-2 and Comparative Example 1-1, and illustrates the relationship between the frequency and the insertion loss (IL). In Examples 1-1 and 1-2, since the concentricity of the insulated electric wires was 91% or more, suck-out did not occur, and communication stability was good. On the other hand, in Comparative Example 1-1, suck-out occurred around 5.9 GHZ. In Comparative Example 1-1, since the concentricity of the insulated electric wires was less than 91%, suck-out occurred at a frequency corresponding to the twist pitch of the twisted wire, and communication stability was poor.

### [Experiment 2]

Example 2-1 and Comparative Examples 2-1 and 2-2 were used to verify the influence of differences in the foaming ratio of the insulator on communication stability.

As a method of producing the insulated electric wire, first, polypropylene was foam-extruded onto a stranded conductor (cross-sectional area: 0.13 sq, outer diameter: 0.48 mm) formed by twisting seven soft copper element wires together, and an insulator (foamed polypropylene) was thus formed. The temperature of the extruder for foam extrusion molding was set to 170 to 220° C., and high-pressure nitrogen gas pressurized by a gas booster was injected and mixed from a middle portion of the extruder. At that time, the foaming ratio of the insulator was set to 37% in Example 2-1, 40% in Comparative Example 2-1, and 45% in Comparative Example 2-2. Further, the concentricity of the insulated electric wire was set to 95% or more in all cases. In each case, two insulated electric wires were produced under the above-mentioned conditions.

The obtained insulated electric wires were twisted together to produce the twisted wire. The twist pitch of the twisted wire was set to 17 mm in Example 2-1 and Comparative Example 2-1 and 23 mm in Comparative Example 2-2. Further, a metal foil shield was provided around the twisted wire by lateral winding. The resin layer of the metal foil shield was a PET film, and the thickness of the resin layer was 12 μm. The metal layer of the metal foil shield was aluminum, and the thickness of the metal layer was 10 μm. Thus, the ratio of the thickness of the metal layer with respect to the thickness of the resin layer was 0.83. Note that the thickness of the metal foil shield was 50 μm or less.

Further, after a metal braid formed of metal wires was provided on an outer periphery of the metal foil shield, the assembly was set in an extruder (set temperature: 140 to 180° C.), and was covered with a sheath having a thickness of 0.4 mm by extrusion molding to produce a test sample of the communication cable.

FIG. 6 is a graph comparing communication stability of the communication cables according to Example 2-1 and Comparative Examples 2-1 and 2-2, and illustrates the relationship between the frequency and the insertion loss (IL). In Example 2-1, since the foaming ratio of the insulator was 39% or less, suck-out did not occur, and communication stability was good. On the other hand, suck-out occurred around 6.3 to 6.7 GHZ in Comparative Example 2-1, and suck-out occurred around 5 GHz in Comparative Example 2-2. In Comparative Examples 2-1 and 2-2, since the foaming ratio of the insulator was greater than 39%, the insulator tended to be crushed, suck-out occurred, and communication stability was poor.

### [Experiment 3]

Examples 3-1 to 3-5 and Comparative Examples 3-1 to 3-7 were used to verify the influence of differences in the D hardness of the insulator and in the metal foil shield on communication stability.

As a method of producing the insulated electric wire, first, polypropylene was foam-extruded onto a stranded conductor (cross-sectional area: 0.13 sq, outer diameter: 0.48 mm) formed by twisting seven soft copper element wires together, and an insulator (foamed polypropylene) was thus formed. The temperature of the extruder for foam extrusion molding was set to 170 to 220° C., and high-pressure nitrogen gas pressurized by a gas booster was injected and mixed from a middle portion of the extruder. At that time, the foaming ratio of the insulator was set to 35% in all cases. Further, the concentricity of the insulated electric wire was set to 95% or more in all cases. In each case, two insulated electric wires were produced under the above-mentioned conditions. The measurement results of the D hardnesses of the insulators are illustrated in Table 1.

The obtained insulated electric wires were twisted together to produce the twisted wire. The twist pitch of the twisted wire was set to 17 mm. Further, a metal foil shield was provided around the twisted wire by lateral winding. The resin layer of the metal foil shield was a PET film, and the metal layer of the metal foil shield was aluminum. Further, the ratio of the thickness of the metal layer with respect to the thickness of the resin layer in the metal foil shield was set as illustrated in Table 1. Note that the thickness of the metal foil shield was 50 μm or less in all cases.

Further, after a metal braid formed of metal wires was provided on an outer periphery of the metal foil shield, the assembly was set in an extruder (set temperature: 140 to 180° C.), and was covered with a sheath having a thickness of 0.4 mm by extrusion molding to produce a test sample of the communication cable.

### (Manufacturability)

In each case, those in which the communication cable was successfully produced by the method described above were evaluated as acceptable (Pass), and those in which the communication cable failed to be produced or defects occurred during production were evaluated as unacceptable (Fail). The evaluation results are illustrated in Table 1.

### (Communication Stability)

In each case, when communication stability of the communication cable produced by the method described above was evaluated, those in which no suck-out occurred were evaluated as acceptable (Pass), and those in which suck-out occurred were evaluated as unacceptable (Fail). The evaluation results are illustrated in Table 1. Note that, for cases in which the communication cable failed to be produced and communication stability was not evaluated, the result was determined as “Not measurable”, and was treated as unacceptable.

### (Comprehensive Evaluation)

Cases in which both the manufacturability evaluation and the communication stability evaluation were acceptable were evaluated as acceptable (Pass), and cases in which either evaluation was unacceptable were evaluated as unacceptable (Fail). The evaluation results are illustrated in Table 1.

TABLE 1

| | | Ratio of thickness | | | |
|---|---|---|---|---|---|
| | D | of metal layer with | | | |
| | hardness of | respect to thickness | | Communication | Comprehensive |
| | insulator | of resin layer | Manufacturability | stability | evaluation |
| Example 3-1 | 62 | 0.83 | Pass | Pass | Pass |
| Example 3-2 | 65 | 0.40 | Pass | Pass | Pass |
| Example 3-3 | 67 | 0.40 | Pass | Pass | Pass |
| Example 3-4 | 70 | 0.40 | Pass | Pass | Pass |
| Example 3-5 | 62 | 0.67 | Pass | Pass | Pass |
| Comparative | 59 | 1.67 | Fail | Fail | Fail |
| Example 3-1 | | | | | |
| Comparative | 59 | 0.83 | Pass | Fail | Fail |
| Example 3-2 | | | | | |
| Comparative | 62 | 0.33 | Pass | Fail | Fail |
| Example 3-3 | | | | | |
| Comparative | 65 | 0.20 | Fail | Not | Fail |
| Example 3-4 | | | | measurable | |
| Comparative | 65 | 1.25 | Fail | Pass | Fail |
| Example 3-5 | | | | | |
| Comparative | 71 | 0.40 | Fail | Not | Fail |
| Example 3-6 | | | | measurable | |
| Comparative | 62 | 1.50 | Fail | Pass | Fail |
| Example 3-7 | | | | | |

From Table 1, in the communication cables of Examples 3-1 to 3-5, the D hardness of the insulator was 60 or more and 70 or less, and the ratio of the thickness of the metal layer to the thickness of the resin layer was 0.4 or more and 1.2 or less. Thus, both the evaluation of manufacturability and the evaluation of communication stability were acceptable, and the comprehensive evaluation was acceptable in all cases.

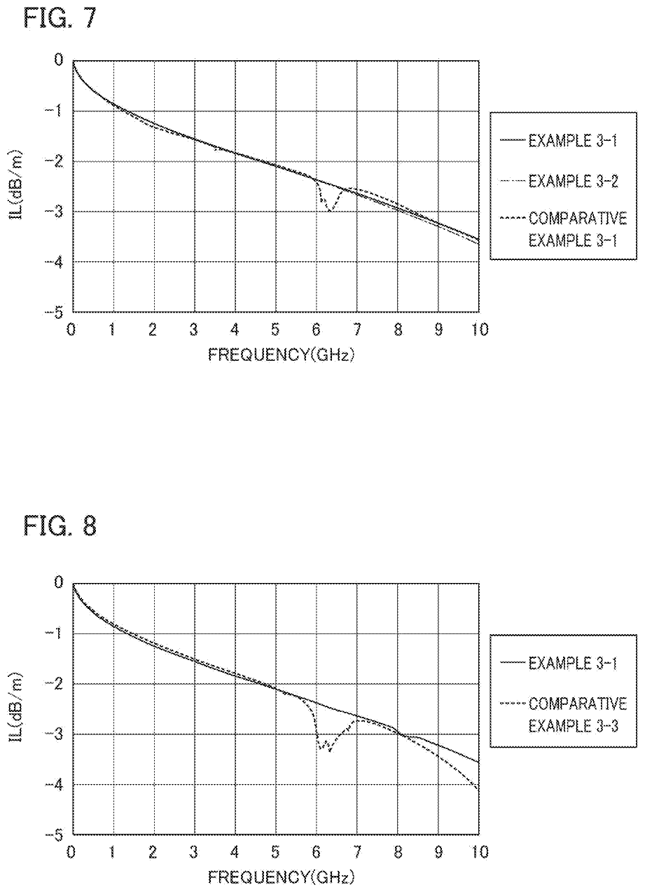

In the communication cable of Comparative Example 3-1, the D hardness of the insulator was less than 60, and the ratio of the thickness of the metal layer to the thickness of the resin layer was greater than 1.2. Thus, the resin layer of the metal foil shield was thin and prone to cutting, defects occurred during production of the communication cable, and the manufacturability evaluation was unacceptable. Meanwhile, FIG. 7 is a graph comparing communication stability of the communication cables according to Examples 3-1 and 3-2 and Comparative Example 3-1, and illustrates the relationship between the frequency and the insertion loss (IL). Suck-out did not occur in Examples 3-1 and 3-2, whereas suck-out occurred around 6.2 to 6.6 GHz in Comparative Example 3-1. In Comparative Example 3-1, since the insulated electric wires were crushed by twisting and foil winding during production of the communication cable, suck-out occurred in the communication stability evaluation, and the result was unacceptable.

In the communication cable of Comparative Example 3-2, the D hardness of the insulator was less than 60, but the ratio of the thickness of the metal layer to the thickness of the resin layer was 0.4 or more and 1.2 or less. Thus, the communication cable was produced. However, since the insulated electric wires were crushed by twisting and foil winding during production of the communication cable, suck-out occurred in the communication stability evaluation, and the result was unacceptable.

In the communication cable of Comparative Example 3-3, the D hardness of the insulator was 60 or more and 70 or less, but the ratio of the thickness of the metal layer to the thickness of the resin layer was less than 0.4. Thus, the communication cable was produced. However, the communication stability evaluation was unacceptable. Meanwhile, FIG. 8 is a graph comparing communication stability of the communication cables according to Example 3-1 and Comparative Example 3-3, and illustrates the relationship between the frequency and the insertion loss (IL). Suck-out did not occur in Example 3-1, whereas suck-out occurred around 5.7 to 6.8 GHz in Comparative Example 3-3. In Comparative Example 3-3, since it was required to increase the foil winding tension during production of the communication cable and, as a result, the insulated electric wires were damaged, suck-out occurred in the communication stability evaluation, and the result was unacceptable.

In the communication cable of Comparative Example 3-4, the D hardness of the insulator was 60 or more and 70 or less, but the ratio of the thickness of the metal layer to the thickness of the resin layer was less than 0.4. In Comparative Example 3-4, since the ratio of the thickness of the metal layer to the thickness of the resin layer was even smaller than that of Comparative Example 3-3, the rigidity of the resin layer was high, and the metal foil shield became stiff. Consequently, it was impossible to perform winding along the twisted wire, and the communication cable was not produced. Thus, the manufacturability evaluation was unacceptable. The communication cable was not produced, and hence communication stability was not evaluated.

In the communication cable of Comparative Example 3-5, the D hardness of the insulator was 60 or more and 70 or less, but the ratio of the thickness of the metal layer to the thickness of the resin layer was greater than 1.2. Thus, the resin layer of the metal foil shield was thin and prone to cutting, and the metal layer was thick and tended to wrinkle. Consequently, defects occurred during production of the communication cable, and the manufacturability evaluation was unacceptable. On the other hand, in the communication stability evaluation, no suck-out occurred, and the result was acceptable.

In the communication cable of Comparative Example 3-6, the D hardness of the insulator was greater than 70, but the ratio of the thickness of the metal layer to the thickness of the resin layer was 0.4 or more and 1.2 or less. Thus, during production of the communication cable, distortion during twisting was increased, problems such as opening of the twisted wire occurred, and the communication cable was not produced. Consequently, the manufacturability evaluation was unacceptable. The communication cable was not produced, and hence communication stability was not be evaluated.

In the communication cable of Comparative Example 3-7, the D hardness of the insulator was 60 or more and 70 or less, but the ratio of the thickness of the metal layer to the thickness of the resin layer was greater than 1.2. Thus, the resin layer of the metal foil shield was thin and prone to cutting, defects occurred during production of the communication cable, and the manufacturability evaluation was unacceptable. On the other hand, in the communication stability evaluation, no suck-out occurred, and the result was acceptable.

Thus, since the communication cables of Comparative Examples 3-1 to 3-7 were unacceptable in either the manufacturability evaluation or the communication stability evaluation, the comprehensive evaluation was unacceptable in all cases.

### [Experiment 4]

Examples 4-1 and 4-2 and Comparative Examples 4-1 and 4-2 were used to verify the influence of differences in the twist pitch of the twisted wire on communication stability.

As a method of producing the insulated electric wire, first, polypropylene was foam-extruded onto a stranded conductor (cross-sectional area: 0.13 sq, outer diameter: 0.48 mm) formed by twisting seven soft copper element wires together, and an insulator (foamed polypropylene) was thus formed. The temperature of the extruder for foam extrusion molding was set to 170 to 220° C., and high-pressure nitrogen gas pressurized by a gas booster was injected and mixed from a middle portion of the extruder. At that time, the foaming ratio of the insulator was set to 35% in all cases. Further, the concentricity of the insulated electric wire was set to 95% or more in all cases. In each case, two insulated electric wires were produced under the above-mentioned conditions.

The obtained insulated electric wires were twisted together to produce the twisted wire. The twist pitch of the twisted wire was set to 15 mm in Example 4-1, 17 mm in Example 4-2, 11 mm in Comparative Example 4-1, and 23 mm in Comparative Example 4-2. Further, a metal foil shield was provided around the twisted wire by lateral winding. The resin layer of the metal foil shield was a PET film, and the thickness of the resin layer was 12 μm. The metal layer of the metal foil shield was aluminum, and the thickness of the metal layer was 10 μm. Thus, the ratio of the thickness of the metal layer with respect to the thickness of the resin layer was 0.83. Note that the thickness of the metal foil shield was 50 μm or less.

Further, after a metal braid formed of metal wires was provided on an outer periphery of the metal foil shield, the assembly was set in an extruder (set temperature: 140 to 180° C.), and was covered with a sheath having a thickness of 0.4 mm by extrusion molding to produce a test sample of the communication cable.

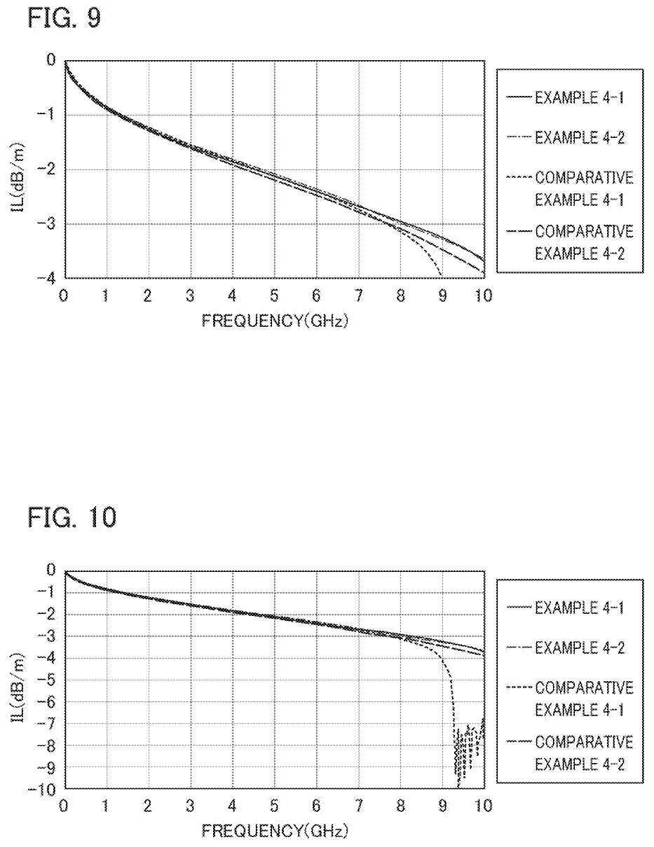

FIGS. 9 and 10 are graphs comparing communication stability of the communication cables according to Examples 4-1 and 4-2 and Comparative Examples 4-1 and 4-2, and illustrate the relationship between the frequency and the insertion loss (IL). FIG. 10 is a graph in which the scale of the vertical axis of FIG. 9 is changed. In Examples 4-1 and 4-2, since the twist pitch of the twisted wire was 15 mm or more and 21 mm or less, suck-out did not occur, and communication stability was good. On the other hand, in Comparative Example 4-1, suck-out occurred around 8 to 10 GHz. In Comparative Example 4-1, since the twist pitch of the twisted wire was less than 15 mm, the inner wire tended to be crushed, suck-out occurred, and communication stability was poor. Further, in Comparative Example 4-2, communication performance was deteriorated in a region of 5 GHz or higher, and was deteriorated by about 9% around 10 GHz as compared with Examples 4-1 and 4-2. In Comparative Example 4-2, since the twist pitch of the twisted wire was greater than 21 mm, the metal foil tended to enter the valleys of the twist, the area occupancy ratio of the air layer between the twisted wire and the metal foil shield was reduced, the effective relative permittivity of the communication cable was deteriorated, and communication stability was poor.

### [Experiment 5]

Examples 5-1 and 5-2 and Comparative Examples 5-1 and 5-2 were used to verify the influence of differences in the coupling ratio of the twisted wire on communication stability.

As a method of producing the insulated electric wire, first, polypropylene was foam-extruded onto a stranded conductor (cross-sectional area: 0.22 sq, outer diameter: 0.60 mm) formed by twisting seven soft copper element wires together, and an insulator (foamed polypropylene) was thus formed. The temperature of the extruder for foam extrusion molding was set to 170 to 220° C., and high-pressure nitrogen gas pressurized by a gas booster was injected and mixed from a middle portion of the extruder. At that time, the foaming ratio of the insulator was set to 35% in all cases. Further, the concentricity of the insulated electric wire was set to 95% or more in all cases. In each case, two insulated electric wires were produced under the above-mentioned conditions.

The obtained insulated electric wires were twisted together to produce the twisted wire. The twist pitch of the twisted wire was set to 17 mm. The coupling ratio of the twisted wire was set to 14.01% in Example 5-1, 12.05% in Example 5-2, 11.98% in Comparative Example 5-1, and 11.00% in Comparative Example 5-2. Further, a metal foil shield was provided around the twisted wire by lateral winding. The resin layer of the metal foil shield was a PET film, and the thickness of the resin layer was 12 μm. The metal layer of the metal foil shield was aluminum, and the thickness of the metal layer was 10 μm. Thus, the ratio of the thickness of the metal layer with respect to the thickness of the resin layer was 0.83. Note that the thickness of the metal foil shield was 50 μm or less.

Further, after a metal braid formed of metal wires was provided on an outer periphery of the metal foil shield, the assembly was set in an extruder (set temperature: 140 to 180° C.), and was covered with a sheath having a thickness of 0.4 mm by extrusion molding to produce a test sample of the communication cable.

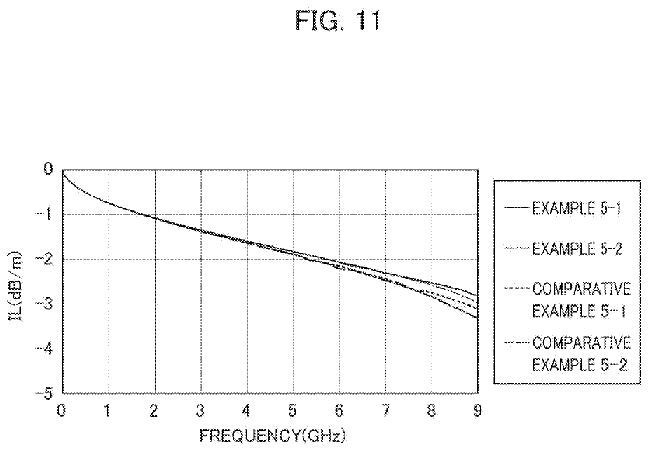

FIG. 11 is a graph comparing communication stability of the communication cables according to Examples 5-1 and 5-2 and Comparative Examples 5-1 and 5-2, and illustrates the relationship between the frequency and the insertion loss (IL). In Examples 5-1 and 5-2, since the coupling ratio of the twisted wire was 12.0% or more and 20.0% or less, the insertion loss around a frequency of 9 GHz was successfully maintained at −3 dB/m or more, and communication stability was good. On the other hand, in Comparative Examples 5-1 and 5-2, the insertion loss around a frequency of 9 GHz was not maintained at −3 dB/m or more, and communication stability was poor.

From those result, it can be understood that a communication cable with improved manufacturability and communication stability can be achieved by appropriately selecting the material properties of the communication cable, the specifications of the metal foil shield, and the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A communication cable comprising:
two insulated electric wires that are twisted together, the two insulated electric wires each including a conductor and an insulator covering the conductor;
a metal foil shield that is provided around the two insulated electric wires by lateral winding; and
a sheath that is provided on an outer periphery of the metal foil shield, wherein the insulator is a foamed body, and a foaming ratio of the insulator is 39% or less, and
a concentricity of each of the two insulated electric wires is 94% or more and 100% or less.

2. The communication cable according to claim 1, wherein
a coupling ratio of the two insulated electric wires is 12.0% or more.

3. The communication cable according to claim 1, wherein
the metal foil shield includes a resin layer and a metal layer, and a ratio of a thickness of the metal layer with respect to a thickness of the resin layer is 0.4 or more and 1.2 or less, and
a D hardness of the insulator is 60 or more and 70 or less.

4. The communication cable according to claim 1, wherein
a metal braid provided so as to cover the outer periphery of the metal foil shield is arranged between the metal foil shield and the sheath.

5. The communication cable according to claim 3, wherein
the metal layer of the metal foil shield contains at least one of aluminum or copper.

6. The communication cable according to claim 3, wherein
the resin layer of the metal foil shield contains polyethylene terephthalate.

7. The communication cable according to claim 1, wherein
a base resin forming the insulator is foamed polypropylene.

8. The communication cable according to claim 1, wherein
a twist pitch of the two insulated electric wires is 15 mm or more and 21 mm or less.

9. The communication cable according to claim 1, wherein
a foil winding pitch of the metal foil shield is 18.5 mm or less.

10. The communication cable according to claim 1, wherein
the material forming the conductor is not plated.
